(19) United States
(12) Patent Application Publication
(10) Pub. No.: US 2007/0221137 A1
(43) Pub. Date: Sep. 27, 2007

(54) Farrowing pens

(76) Inventor: Pierre Lareau, Bedford (CA)

Correspondence Address: Eric Fincham, 316 Knowlton Road, Lac Brome, J0E 1V0, CA

(21) Appl. No.: 11/387,288

(22) Filed: Mar. 22, 2006

(51) Int. Cl. A01K 1/02

(52) U.S. Cl. 119/503

(57) ABSTRACT

A device and method for use in a farrowing pen, the device comprising a housing, first and second mounting members for mounting the housing member on a farrowing pen, a blower mounted in the housing, an air inlet and air outlet formed in the housing to make air flow to and from the blower, a motion detector, and a control circuit operative to operate the blower when motion is detected and to stop the blower when motion ceases. The device is arranged such that the motion detector will detect the presence of the sow in an upright position and the control circuit will operate the blower, while when the sow is in a prone position, the motion detector will not detect movement and the blower will not operate.

### FIELD OF THE INVENTION

The present invention relates to farrowing pens and more particularly, relates to an apparatus and method for protecting pre-weaned piglets.

### BACKGROUND OF THE INVENTION

Pre-weaned pig mortality, is a result of being crushed by the sow in a farrowing pen, and can account for up to 10% loss of all pre-weaned pigs. The problem arises as the sow, in a farrowing area, attempts to lie down and/or change position and as a result the piglets are crushed.

In a farrowing pen, it is common practice to have human supervision and to cause the sow to get up by hitting the sow lightly when she lays down on a piglet. However, in order to prevent the problem of piglet death, human presence is required 24 hours a day. Naturally, this cost is substantial and can render pig farming uneconomical.

### SUMMARY OF THE INVENTION

It is an object of the present invention to provide a method an apparatus to reduce the instance of piglet death due to crushing by the sow.

It is a further object of the present invention to provide a method wherein the prevention of piglet death due to crushing by the sow may be automated.

In greater detail, the device of the present invention includes a housing which has mounting members such that the device may be mounted on the side of a farrowing pen by means of the rails which form the pen. The housing includes a blower mounted therein, there being an inlet and an outlet to the blower. Preferably, the blower is of the squirrel cage type. The inlet to the blower will be on one of the housing side walls. Preferably, there is provided a grill or a pre-filter to prevent extraneous manner from entering the blower.

The outlet is located in the front wall with diffuser means at the outlet to direct the air flow downwardly and outwardly. The diffuser means are such that the air is directed outwardly at an angle of between 20 and 55°.

The mounting means preferably comprise a pair of C-shape members into which the rails 35 of the farrowing pen will fit. There are then provided retaining means which are movable to prevent removal from the rails.

There is also preferably provided an upper mounting means which is designed to be adjustable such that it may likewise amount on a bar of the farrowing pen and the placement of the device varied.

The motion detector may be any conventional one such as is known in the art. The motion detector is preferably adjustable for its range and direction. The motion detector will be connected to a suitable control means such that when motion detector detects a motion, it will direct air downwardly and outwardly to prevent the piglets from lying in the area where the sow would lie down. When the sow is in the prone position, the motion detector will not detect any movement and accordingly the blower will cease blowing air. Naturally, the control means may utilize timers such that the air will continue blowing for a preset time after detection of movement.

### BRIEF DESCRIPTION OF THE DRAWINGS

Having thus generally described the invention, reference will be made to the accompanying drawings illustrating an embodiment thereof, in which:

FIG. 1 is a perspective view of the device of the present invention as used in a farrowing pen;

FIG. 2 is a side elevational view thereof;

FIG. 3 is a cross sectional view through the farrowing pen showing the device of the present invention;

FIG. 4 is a cross sectional view;

FIG. 5 is a front elevational view thereof;

FIG. 6 is a detained view of the diffuser portion of the device;

FIG. 7 is a perspective view of a further embodiment of a mounting means for the device; and

FIG. 8 is a side elevational view thereof.

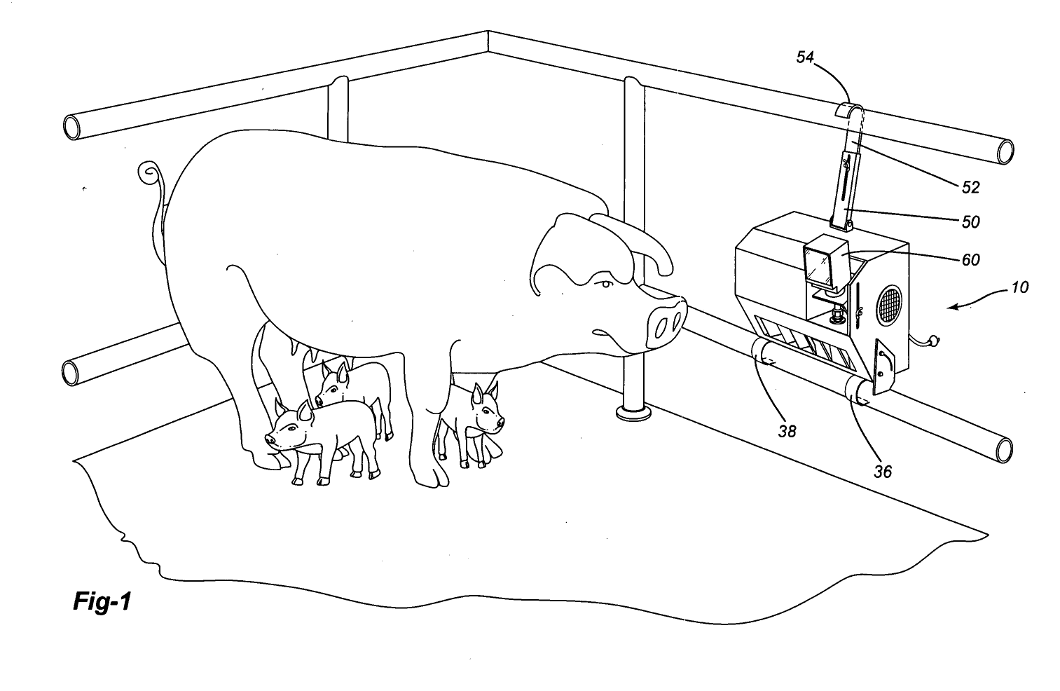

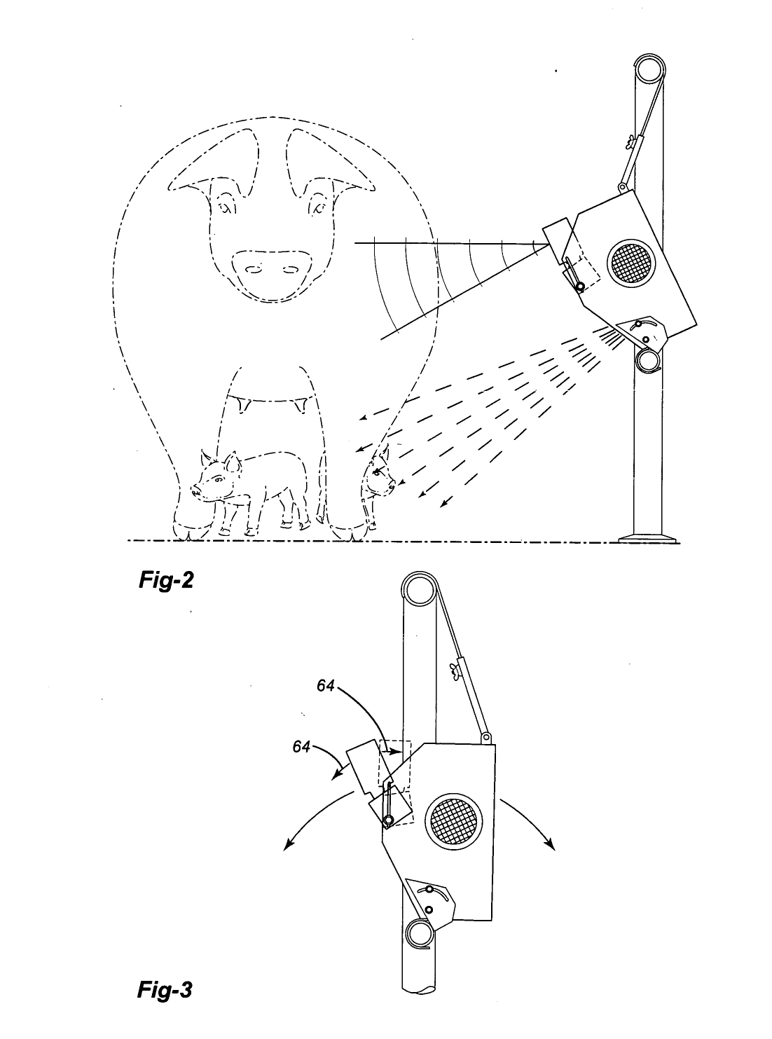

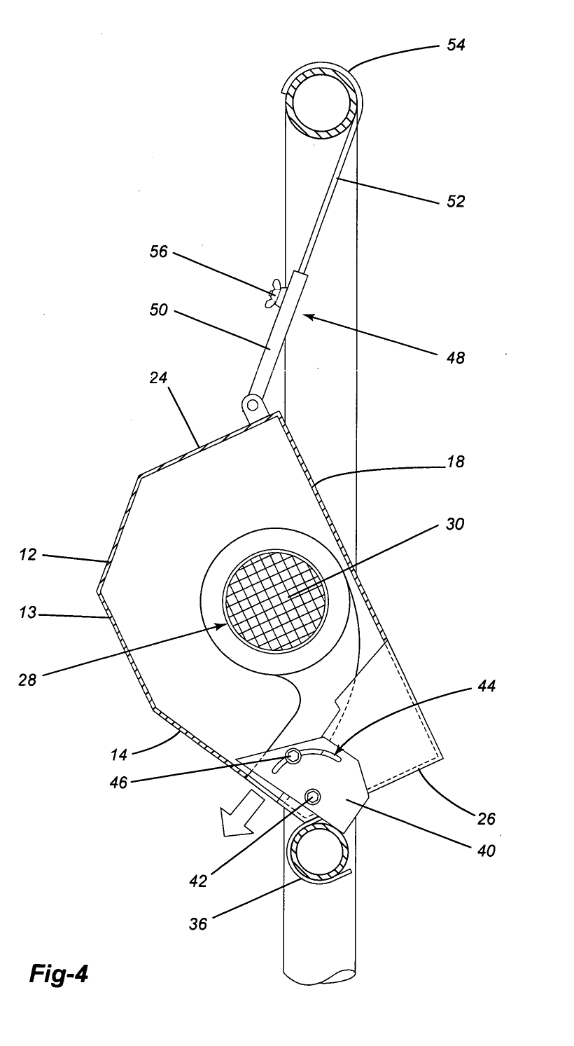

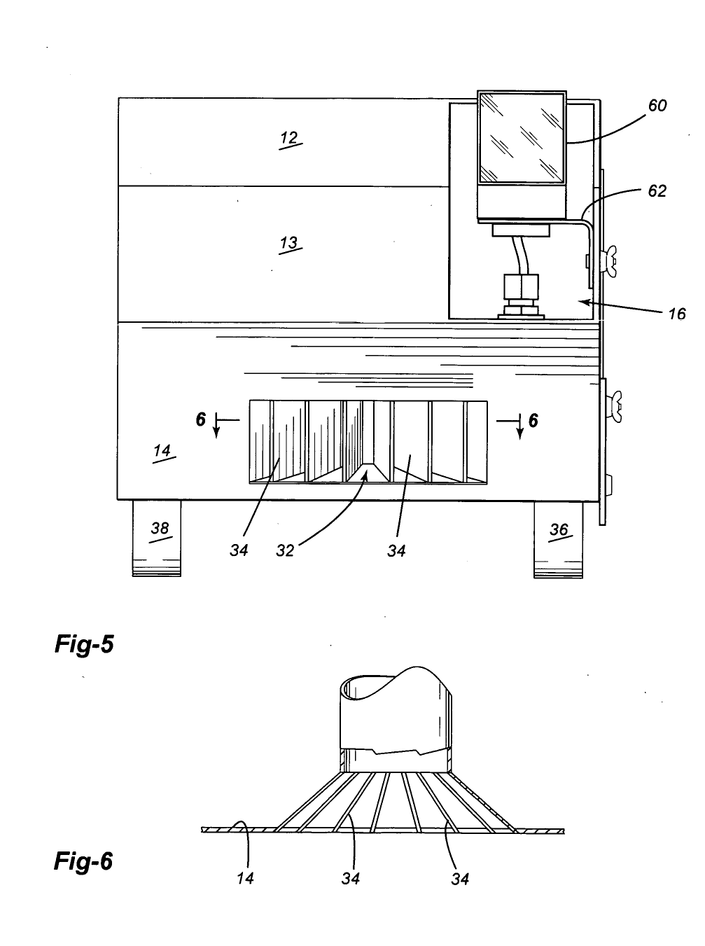

### DETAILED DESCRIPTION OF THE DRAWINGS

Referring to the drawings in greater detail and by reference characters thereto, there is illustrated an apparatus designed to reduce the instance of piglet death due to crushing, and which apparatus is generally designated by reference numeral 10.

Device 10 includes an upper front wall 12, a middle front wall 13 and a lower front wall 14 angled with respect thereto. There is provided a recessed portion 16 in upper front wall 12.

The device also has a rear wall 18, a pair side walls 20, 22 and a top wall 24. A bottom wall 26 extends between the side walls 20, 22, rear wall 18 and lower front wall 14.

In side wall 20, there is provided an air inlet or intake 28 and which is covered by suitable mesh 30 to prevent extraneous manner from entering therein. Mounted internally (not shown) is a suitable fan or blower, preferably of the squirrel cage type.

An outlet 32 is provided in lower front wall 14 and as will be seen, there is provided a plurality of diffuser plates 34.

For mounting the device on the farrowing pen, there are provided a pair of C-shaped bottom mounting members 36, 38. Associated with C-shaped bottom mounting member 36, is a side locking plate 40. Side locking plate 40 is mounted at a pivot point 42 on side wall 20 and there is provided an arcuate slot 44 in plate 40 to engage a pin 46. Thus, side locking plate 40 can be moved into and out of a locking position to maintain C-shaped bottom mounting member 36 in position with respect to the farrowing pen. A similar arrangement is provided on the side of the device for mounting member 38.

There is also provided an upper mounting assembly 48 which comprises a first member 50 pivotally connected to top wall 24 with a second telescoping member 52 engaged therewith. At the end of telescoping member 52, there is provided a C-shaped mounting member 54. The length of the arm formed by members 50, 52 may be varied with a locking screw 56 being provided.

The device includes a motion detector 60 mounted on a bracket 62 with the sensor being movable pivotally as shown by arrows 64.

Thus, the device 10 may be mounted on the rails of a farrowing pen with the adjustability of upper mounting assembly 48 permitting the correct positioning of the same. As indicated by the arrows, the motion detector 60 will be pivotally moved to aim at the correct area.

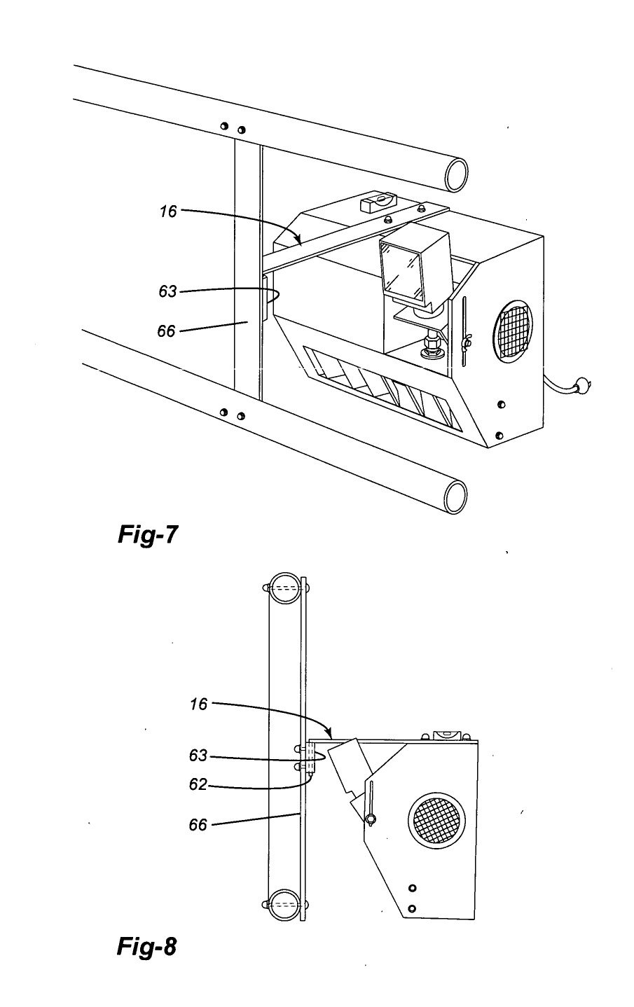

In the embodiment of FIGS. 7 and 8, the mounting means comprises an L-shaped member 16 having the longer leg secured to the upper portion of the device. Lower leg 62 is designed to fit within a bracket 63 mounted on a post 66 extending between horizontally extending rails.

It will be understood that the above described embodiment is for purposes of illustration only and that changes and modifications may be made thereto without departing from the spirit and scope of the invention.

I claim:

1. A device for use in a farrowing pen, the device comprising:
a housing having a front wall, a rear wall, a pair of side walls, a top wall and a bottom wall;
first and second mounting members located on said bottom wall, each mounting members having a generally C-shaped configuration, locking means for securing said mounting members to a rail;
an upper mounting assembly;
a blower mounted in said housing;
an air inlet and an air outlet formed in said housing to permit air flow to and from said blower respectively;
said air outlet being located in said front wall, said air outlet having diffuser means so as to direct air flowing therefrom downwardly and outwardly;
motion detector means mounted on one of said housing;
control means operative to operate said blower when motion is detected and to stop said blower when said motion ceases.

2. The device of claim 1 wherein said air inlet is formed in one of said side walls.

3. The device of claim 2 further including a protective screen mounted over said air inlet.

4. The device of claim 1 wherein said blower is a squirrel cage blower.

5. The device of claim 1 wherein said upper mounting assembly comprises a pair of telescoping members, a distal end of said telescoping members having a T-shaped configuration for mounting on a farrowing pen rail.

6. The device of claim 5 further including means for locking said telescoping members in a desired position.

7. The device of claim 1 wherein said motion detector means are pivotally mounted on said housing.

8. A method for the prevention of piglet death in a farrowing pen, the method comprising the steps of:
providing a farrowing pen;
mounting a device on said farrowing pen, said device having a blower, directing said blower such that air blowing therefrom extends downwardly and outwardly at the floor of said pen;
mounting a motion detector such that when a sow is present in an upright position in said pen and movement is detected, said blower will operate to blow air to prevent piglets from going underneath said sow, and stopping said flow of air when said sow is in a prone position.

9. In a farrowing pen, the improvement comprising a device as defined in claim 1 mounted on a side wall of said farrowing pen, said device being mounted such that said motion detector will detect the presence of a sow in an upright position and said control means will operate said blower when said sow is in said upright position, and said control motion detector means will not detect movement when said sow is in a prone position.
